(19) United States
(12) Patent Application Publication
(10) Pub. No.: US 2020/0096360 A1
(43) Pub. Date: Mar. 26, 2020

(54) METHOD FOR PLANNING TRAJECTORY OF VEHICLE

(71) Applicant: Visteon Global Technologies, Inc., Van Buren Township, MI (US)

(72) Inventors: Martin Pfeifle, Seewald (DE); Axel Torschmied, Cologne (DE); Christine Schreck, Weinheim (DE); Matthias Otto, Pfinztal-Sollingen (DE)

(21) Appl. No.: 16/577,258

(22) Filed: Sep. 20, 2019

(30) Foreign Application Priority Data
Sep. 21, 2018 (EP) 18196059.2

(51) Int. Cl. G01C 21/36

(52) U.S. Cl. CPC G01C 21/3691; G01C 21/3629

(57) ABSTRACT

A method for operating a navigation system of an ego vehicle includes: obtaining information about vehicles in a region proximate the ego vehicle; determining trajectories of the vehicles proximate the ego vehicle based on the obtained information; comparing the trajectories of the vehicles proximate the ego vehicle with a selected route path of the ego vehicle; and based on a determination that at least one vehicle proximate the ego vehicle was driving, is currently driving, or will be driving along the selected route pate, generating and outputting an instruction to a driver of the ego vehicle to follow the at least one vehicle.

### CROSS-REFERENCES TO RELATED APPLICATIONS

This patent application claims priority to European Patent Application Serial No. 18196059.2, filed Sep. 21, 2018, which is incorporated herein by reference in its entirety.

### TECHNICAL FIELD

One or more embodiments described herein relate to a method for operating a navigation system for guiding a driver of an ego vehicle to a desired destination along a selected route path. In particular, the method may be implemented in a program, which is executed by a computer. Furthermore, one or more embodiments described herein relate to a navigation system for guiding a driver of an ego vehicle to a desired destination along a selected route path. Particularly, the navigation system may be part of, or work in conjunction with, an advanced driver-assistance system (ADAS).

### BACKGROUND

In order to guide a driver of a vehicle to a specified goal along a selected route, most navigation systems use turn-by-turn navigation. Directions for following the selected route are continually presented to the driver in the form of audible and/or graphical instructions. Turn-by-turn navigation systems typically use an electronic voice to inform the user whether to turn left or right, continue straight, the street name, and a remaining distance to the turn. A typical instruction of a turn-by-run navigation system may include a command such as, “In three hundred meters, turn right into Elm Street.” However, for some drivers such instructions may be difficult to follow since correctly judging the distance may not be an easy task for untrained humans. Moreover, the street name may not be useful information for a driver who is not familiar with the area.

In order to provide instructions to which a driver may react more intuitively, it has been suggested to include visual clues along the road such as traffic lights, points of interest, outstanding buildings, bridges, tunnels, or other landmarks in the instructions. Such an instruction may include a command such as, “After the church, turn left.”

However, using static objects as references for guiding a driver requires that these objects are visible and easily recognizable at all times. Furthermore, when driving, the available time for spotting and recognizing a static reference point on the side of the road is limited. Other road participants around the ego vehicle have to be observed by the driver of the ego vehicle in order to maintain situational awareness and safely navigate in traffic.

### BRIEF SUMMARY

One or more embodiments describe a method for operating a navigation system for guiding a driver of an ego vehicle to a desired destination along a selected route path. For example, the method aims at guiding a driver of the ego vehicle by providing an instruction to follow another vehicle. In the following, the term vehicle is understood to refer to any kind of suitable road participant including, for example, cars, motorcycles, trucks, buses, and bicycles. For example, an instruction, such as, “Follow the vehicle in front of you taking a left turn,” may be provided to the driver of the ego vehicle. Thus, a more natural and more intuitive way of guiding a driver may be obtained.

According to an aspect, a method for operating a navigation system for guiding a driver of an ego vehicle to a desired destination along a selected route path comprises a step of obtaining information about vehicles in a region around the ego vehicle. For example, information about vehicles in front the ego vehicle may be acquired. This way it may be possible to identify a vehicle in front of the ego vehicle, which may be followed in order to follow the route path.

Furthermore, according to another aspect, the behavior of vehicles around the ego vehicle may be predicted. For example, a preceding vehicle in front of the ego vehicle may have a right turn signal on and may be approaching an intersection. As part of the method of operating the navigation system, a prediction may occur based on detecting the right turn signal and upcoming intersection that the preceding vehicle is likely turning right at the intersection. If the route path to the desired destination also requires the right turn at the intersection, the navigation system may instruct, “Follow the vehicle in front of you taking the right turn.” If the route path does not require the right turn, then the navigation system may i) instruct to not follow the vehicle in front, ii) remain silent, unless the navigation system detects that the ego vehicle is incorrectly following the vehicle in front making the right turn, or iii) issue another instruction, like to continue straight. As another example, the behavior of a vehicle currently behind or next to the ego vehicle may be predicted. From the prediction, the navigation system may instruct to allow the trailing vehicle to pass and/or fall behind the trailing vehicle. After the trailing vehicle has overtaken the ego vehicle, the navigation system may instruct to follow the vehicle now in front of the ego vehicle.

According to an aspect, the method may comprise a step of determining trajectories of the vehicles around the ego vehicle based on the obtained information. In order to identify a vehicle which may be followed, it may be necessary to determine the trajectory of that vehicle. This may be done a plurality of different ways. For generating an instruction to follow another vehicle, it may be sufficient to determine only a relatively short trajectory of that vehicle. For example, it may be sufficient to determine the trajectory of another vehicle within a region of, for example, an intersection, a junction, a turn, a roundabout, an interchange, an entrance, or an exit of a highway, and the like.

According to a further aspect, the method may comprise a step of comparing the trajectories of the vehicles around the ego vehicle with the selected route path. In other words, the determined trajectories of surrounding vehicles (i.e., vehicles around the ego vehicle) are analyzed in light of the planned trajectory of the ego vehicle. If there is a match between a determined trajectory of a surrounding vehicle and the planned trajectory of the ego vehicle, and the ego vehicle is behind the surrounding vehicle, the ego vehicle may follow the surrounding vehicle.

It may be sufficient to determine a match between the trajectories along a relatively short section of the route path, which allows the ego vehicle to follow a surrounding vehicle in order to continue along the selected route path. For example, in order to identify a suitable surrounding vehicle to follow, it may be sufficient to determine a match between the trajectories within a region of, for example, an intersection, a junction, a turn, a roundabout, an interchange, an entrance or an exit of a highway, and the like. In some cases, it may be sufficient to identify a match of only a few tens of meters. The rate at which the trajectories of surrounding vehicles are analyzed may depend for example on a speed of the ego vehicle or on a density of nodes in the route path. For this purpose, the selected route path may be analyzed in order to detect nodes in the route path, at which a change of direction such as a turn will be required. Accordingly, threshold distances before or threshold radii around the detected nodes may be defined. Once the ego vehicle crosses such a threshold (or enters a radius), a suitable vehicle to follow needs to be identified by analyzing trajectories of surrounding vehicles. Once a suitable vehicle to follow has been identified, an instruction to follow the vehicle may be generated.

According to an aspect, the behavior of other road participants may be predicted based on an environmental model. The environmental model may comprise data related to the center lines and/or boundary lines of road lanes and data related to detect surrounding vehicles using sensors.

According to an aspect, matching between the trajectories of surrounding vehicles and the ego vehicle can be based on geometrical information only. For example, all (or at least some) former trajectories as well as their current position and heading of all (or at least some) surrounding vehicles around the ego vehicle may be known. For the ego vehicle, the planned route path is also known. Sample points may then be calculated for the routes of the surrounding vehicles and the ego vehicle. Then the average distance between these sample points may be computed by finding the closest sample point on the planned route path to each sample point on a surrounding vehicle's trajectory. The distance may be computed as the Euclidian distance between these sample points. The average Euclidian distance may be used as a basic measure expressing the quality of the match between the planned route and a trajectory of a surrounding vehicle. Once a trajectory of a surrounding vehicle with a sufficient match is identified, the matched surrounding vehicle may be used for generating an instruction for guiding the driver of the ego vehicle.

According to an aspect, if it is determined that one of the surrounding vehicles either was driving, is currently driving, or will be driving along the selected route path, a step of generating and outputting an instruction to the driver of the ego vehicle to follow the one other vehicle may be carried out. This way the driver may be provided with an instruction, which corresponds to the natural and intuitive way, a human passenger may provide an instruction to the driver in order to follow the route path. For example, the instruction may be generated as, “Turn left following the car in front of you,” or, “Follow the car taking the exit on the right.”

According to an aspect, the step of obtaining information about vehicles around the ego vehicle may comprise detecting at least one of a position, a velocity, a heading, a turn signal, and/or a lane assignment of at least one of the surrounding vehicles. This may be by using sensor data generated by at least one sensor. The at least one sensor may be located on the ego vehicle. The at least one sensor may be in communication with the navigation system. The trajectories of the surrounding vehicles may be determined based on at least one of the position, the velocity, the heading, the turn signal and/or the lane assignment of at least one surrounding vehicles. As a sensor for creating the sensor data, at least one of a radar sensor, an infrared sensor, a camera, a stereo-camera, a LiDAR, and a laser sensor may be used. In certain embodiments, a combination of sensors may be used.

According to an aspect, the step of obtaining information about a surrounding vehicle may comprise detecting at least one of a color and/or a brand and/or a make (i.e. the model) and/or a turn signal and/or a type (e.g., car, truck, motorcycle, etc.) of the surrounding vehicle. In particular, one or more sensors may be used for obtaining information about surrounding vehicles. The generated instruction, which is output to the driver, may comprise at least one of the detected color, the brand, the make, the turn signal, and the type of the other vehicle to be followed. For example, an instruction, such as, “Follow the blue Mercedes sedan on the turning left,” or, “Turn right following the red Ferrari indicating a right turn,” or, “Follow the motorcycle straight through the intersection,” may be generated. In case the instruction is visually presented to the driver, a realistic model of the vehicle to follow may be rendered. For this purpose, a database of rendered models, for example three-dimensional graphical representations of vehicles, may be accessible. When a realistic graphical representation of the vehicle to follow is presented to the driver rather than a generic image of the other vehicle, the driver may recognize the vehicle to follow with less effort.

The process of detecting at least one of a color and/or a brand and/or a make (i.e. the model) and/or type of the vehicles near the ego vehicle may comprise acquiring an image and/or a LiDAR point cloud of the surrounding vehicles and processing the image data or point cloud data. The image processing may be executed for example by neural networks trained to detect what type of road participants are present, e.g., whether the road participant is an automobile, a bicycle, a lorry, a pedestrian, or a motorcycle. Further, the neural networks can be trained to detect the brand, the model the color, and/or the type.

According to an aspect, the step of obtaining information about surrounding vehicles may comprise a step of receiving data from the surrounding vehicles using a vehicle-to-vehicle (V2V) interface. V2V allows automobiles to exchange data with each other. Communication between vehicles may be implemented using a wireless connection. The information shared between vehicles may relate to, for example, position information and planned route information such that a match between routes between vehicles can be detected. When the ego vehicle receives, via V2V, route information and position information of vehicles near the ego vehicle, the instruction to follow a vehicle may be generated without the need to further detect the vehicle by means of sensors.

According to an aspect, an instruction may be output to the driver using acoustic signals and/or optical signals. In particular, a voice instruction may be output to the driver. Alternatively or additionally, a visual instruction may be output. The visual instruction may also incorporate information obtained about the vehicle to be followed. For example, an animated or still image of a vehicle resembling the vehicle to be followed may be displayed on a display comprised in the dashboard or in a head-up display.

According to an aspect, the method may further comprise a step of transmitting the obtained information about surrounding vehicles to a server. This may allow the server to determine trajectories of the surrounding vehicles. The process of determining trajectories of surrounding vehicles may involve a high computational effort. By transmitting the data comprising the information about surrounding vehicles to a server, this computationally costly processing may be carried out by the server, which may have much more processing power than a local processor of the ego vehicle. The amount of data, which needs to be exchanged, may be relatively small such that a time delay associated with the data transfer may be small, in particular compared to the time that may be saved by processing the trajectories using the higher processing power of the server.

According to an aspect, the method may further comprise a step of transmitting the selected route path to the server. The server may compare trajectories of the surrounding vehicles with the selected route path. The process of comparing the trajectory of the ego vehicle with the trajectories of surrounding vehicles may require a high computational effort. By transmitting the data comprising the information about surrounding vehicles and about the position and selected route path of the ego vehicle to a server, this computationally costly processing may be carried out by the server, which may have much more processing power than a local processor of the vehicle. The amount of data, which needs to be exchanged, may be relatively small such that a time delay associated with the data transfer may be small, in particular compared to the time that may be saved by processing using the higher processing power of the server.

According to an aspect, there is provided a program implementing a method for operating a navigation system for guiding a driver of an ego vehicle to a desired destination along a selected route path according to at least one aspect described herein. In particular, the program is executed by a computer. The program implementing the method may comprise a plurality of tasks, which may be carried out, by a plurality of processors. All or some of the processors may be provided locally at the ego vehicle and/or all or some of the processors may be provided centrally at a server or within a cloud network with which the ego vehicle may communicate. The program may be stored on a non-transitory computer-readable medium accessible by the server and/or the processor located in the ego vehicle.

According to an aspect, there is provided a navigation system for an ego vehicle, wherein the system comprises a routing unit for selecting a route path for the ego vehicle to a desired destination. For example, the route path may be selected by the driver from one or more possible routes to the desired destination according to one or more requirements or preferences, which may be preset, by the driver. The desired destination may be input by the driver using an input unit. In particular, the navigation system may be implemented as part of an advanced driver-assistance system (ADAS).

According to an aspect, the system may comprise a sensor unit for obtaining sensor data about vehicles in a region around the ego vehicle from a plurality of sensors. In particular, the plurality of sensors may include at least one of a camera, a stereo-camera, a radar, a LiDAR, an inertial measurement unit (IMU), and a receiver for receiving coordinates from a global navigation satellite system (GNSS).

According to an aspect, the system may comprise a processing unit for determining trajectories of the vehicles around the ego vehicle and for comparing the determined trajectories with the selected route path of the ego vehicle. In particular, the processing unit is configured for determining the trajectories of the surrounding vehicles based on the information received from a reception unit. The trajectories may be determined for example by analyzing the received information. For this purpose, the processing unit may execute one or more algorithms for detecting trajectories of surrounding vehicles. For example, the positions of surrounding vehicles detected over time may be tracked over time and compared to information such as lane markings and nodes between lanes comprised in a high-definition (HD) map. The function of comparing the detected trajectories with the selected route path may only be executed for a predetermined section of the route path. For example, the predetermined section may include about ten to one hundred meters of the route path, which is subsequently going to be travelled by the ego vehicle. In a first processing step, the processing unit may analyze the selected route path and detect nodes in the route path, at which a change of direction such as a turn will be required. Then the processing unit may define threshold distances before or threshold radii around the detected nodes. Once a threshold is crossed (or a radius is entered), a suitable vehicle to follow needs to be identified for generating an instruction.

According to an aspect, the system may comprise an instruction unit for generating instructions for following the route path, wherein if the trajectory of one surrounding vehicle matches with the selected route path, the instruction unit may be configured to generate an instruction to follow the one surrounding vehicle. The instruction unit may comprise a database storing visual and/or audio instruction templates. By selecting a suitable template and adding the relevant information, instructions can be generated very efficiently.

According to an aspect, the instruction unit is configured for generating the instructions based on the information received from the reception unit. The instruction unit may be implemented as a separate piece of hardware or by means of a software module executed by one or more processors. Functionally, the instruction unit receives information related to the outcome of a matching process between trajectories from the processing unit and generates the instruction, which can be output to the driver of the ego vehicle by an output unit. Thus, the instruction unit is configured for converting the information received from the processing unit into an instruction, which is provided in a data format suitable for the output unit.

According to an aspect, the system may comprise an output unit for outputting instructions to a driver of the ego vehicle. The output unit may be configured to output the instruction visually and/or acoustically to the driver. For this purpose, the output unit may comprise at least one of a display for displaying a graphical instruction, a speaker for outputting sound, and/or a head-up display (HUD). In particular, the output unit may be part of an ADAS or instrument cluster.

According to an aspect, the system may further comprise a reception unit for receiving information about other vehicles in a region around the ego vehicle from the other vehicles. In particular, the reception unit may receive data from the other vehicles using a vehicle-to-vehicle (V2V) interface. For example, when trajectory information is directly received from surrounding vehicles, a step of calculating trajectories of the surrounding vehicles, which may be computationally cumbersome, may be omitted. Additionally or alternatively, information related to the brand, color, type, and/or model of surrounding vehicles may be received via the V2V interface.

According to an aspect, the system may further comprise a server configured to communicate and exchange data with at least one of the routing unit, the sensor unit, the processing unit, the instruction unit, and the output unit. Data communication may be accomplished for example by means of a wireless network, such as a mobile data network. The server does not need to be a single centrally managed piece of hardware but may be implemented as a cloud computing network with the advantage of redundant components and simplified maintenance.

According to an aspect, the processing unit may be located at the server. Using a processing unit at the server may achieve the advantage of more easily providing more processing power than locally provided at the ego vehicle. On the other hand, tasks may also be divided between a processor at the server and a processor at the ego vehicle in order to decrease the time needed for data processing and to more efficiently use the available processing power.

### BRIEF DESCRIPTION OF THE DRAWINGS

FIG. 1 schematically illustrates a navigation system according to an embodiment.

FIG. 2 shows a process flow schematically illustrating a method according to an embodiment.

FIG. 3 shows a process flow schematically illustrating a method according to an embodiment.

FIG. 4 illustrates an example for route matching using prediction of environmental model.

FIG. 5 illustrates an example for route matching using V2V.

FIG. 6 illustrates an example for route matching based on geometrical relations between trajectories.

### DETAILED DESCRIPTION

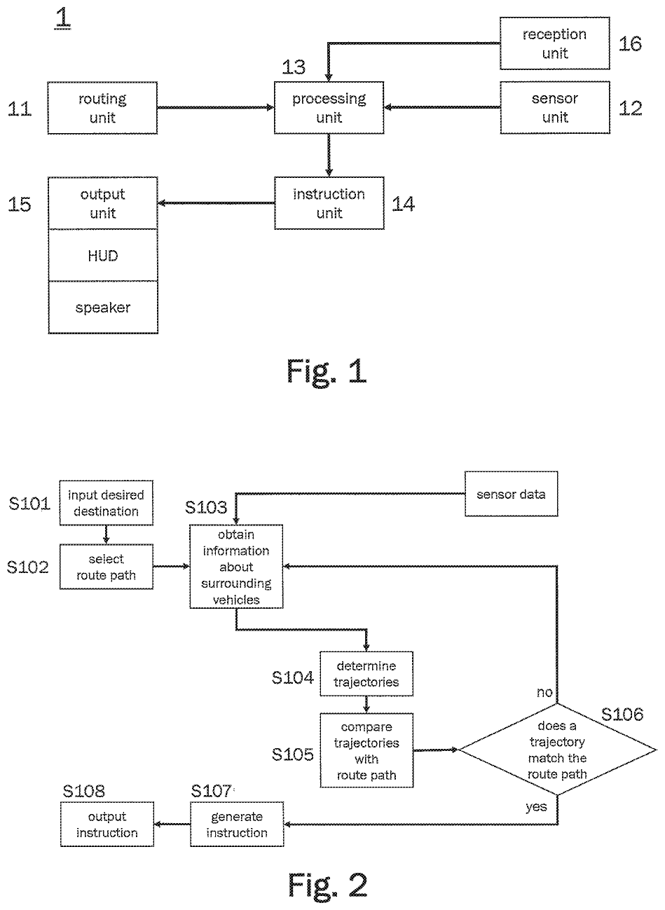

FIG. 1 shows a schematic illustration of a navigation system 1 for an ego vehicle according to an embodiment. The navigation system 1 may comprise a routing unit 11, a sensor unit 12, a processing unit 13, an instruction unit 14, an output unit 15, and a reception unit 16. The navigation system 1 may be implemented as part of an advanced driver-assistance system (ADAS) comprising an instrument cluster. In particular, the navigation system 1 may be used in motor vehicles such as an automobile, a motorcycle, or a truck. In some embodiments, the different units of the navigation system 1 may be implemented as software modules running on one or more electronic control units (ECUs). In particular, the sensor unit 12 and the routing unit 11 may run on different ECUs.

The routing unit 11 may enable the driver of the ego vehicle to select a route path for the ego vehicle to a desired destination. For this purpose, the routing unit 11 may comprise an input unit for receiving input operations by the driver. By means of the input unit, the driver may input a desired destination. The routing unit 11 may then provide one or more possible route paths to the destination, from which the driver may select one route path to follow using the input unit.

The sensor unit 12 may comprise a plurality of sensors for obtaining sensor data about vehicles in a region around the ego vehicle. The sensor unit 12 typically includes at least a camera and a radar. Furthermore, the sensor unit 12 may also comprise a LiDAR. In particular, the camera, the radar, and the LiDAR of the sensor unit 12 may be configured to detect vehicles in a region in front of the ego vehicle. For example, the radar may be used to detect a distance of vehicles in front of the ego vehicle. Furthermore, the sensor unit 12 may comprise a receiver to receive location coordinates of the ego vehicle from a global navigation satellite system (GNSS). Furthermore, the sensor unit 12 may also comprise an inertial measurement unit (IMU) for detecting the location of the ego vehicle when no signal from the GNSS is available (for example in a tunnel).

The processing unit 13 may determine trajectories of the vehicles around the ego-vehicle based on the received information. Furthermore, the processing unit 13 may compare the determined trajectories with the selected route path.

The instruction unit 14 may be configured to generate instructions for following the route. If the trajectory of one surrounding vehicle matches with the selected route path of the ego vehicle, the instruction unit 14 may be configured to generate an instruction to follow the one surround vehicle. Furthermore, the instruction unit 14 may generate the instructions based on the information related to the brand, make, type, or color of the vehicle to follow.

The output unit 15 may comprise a head-up display for displaying visual information on a windscreen of the ego vehicle and an instrument cluster with one or more thin-film-transistor liquid-crystal displays (TFT-LCDs) for providing further visual information to the driver. The output unit 15 may comprise an audio system with at least one speaker for outputting audio to the driver. The output unit 15 may be used for outputting visual and acoustic instructions to the driver of the ego vehicle.

The reception unit 16 may be configured for receiving information about other vehicles in a region around the ego vehicle from the other vehicles. In particular, the reception unit 16 may receive data from the surrounding vehicles using a vehicle-to-vehicle (V2V) interface. This information may be used for determining the trajectories of the surrounding vehicles and/or for generating the instructions.

Embodiments of the system 1 may further comprise a server configured to communicate and exchange data with at least one of the routing unit 11, the sensor unit 12, the processing unit 13, the instruction unit 14, and the output unit 15. In particular, the processing unit 13 may be implemented at the server. For the data transfer between the ego vehicle and the server, the system 1 may be configured to communicate via a mobile data network.

FIG. 2 shows a process flow, which schematically illustrates a method for operating a navigation system 1 for guiding a driver of an ego vehicle to a desired destination along a selected route path, according to one or more embodiments. The method may be carried out by a navigation system 1 as described above with reference to FIG. 1.

In a first process step S101 the driver of the ego vehicle may input a desired destination. This may be done for example by typing a destination using an input device or by using voice input. The navigation system 1 may search for the input destination in a database or on a map which may be stored locally or which may be obtained from a server via a data communication connection.

In a next step S102, a route path may be selected. For example, the driver may be presented with one or more possible route paths from the current location to the desired destination and may select a route path. For example, the driver may select a route path following the shortest distance or a fastest route path requiring the least amount of time. Further possible route paths may be selected according to user-defined requirements such as avoiding toll roads or avoiding border crossings.

After a route path has been selected in step S102, the driver may start his or her journey following instructions output by the navigation system 1. For example, the instructions may be output on a turn-by-turn basis, telling the driver to take a turn left or right or continue straight at intersections. Graphical indications and/or voice commands may be output by the navigation system in order to guide the driver. The timing for outputting the instructions may be triggered by comparing the current location of the ego vehicle with the route path. For example, after selecting a route path, the route path may be divided in to sections according to the necessary maneuvers between sections in order to follow the route path. Each maneuver may correspond to taking a turn or driving along a specified lane. A suitable distance before the maneuver, a threshold may be defined or a threshold radius may be defined around the location where a maneuver needs to be performed. The thresholds may be as a trigger for starting the process of generating an instruction.

In the following, the method may include a command for following another vehicle along the route path. These steps may be executed each time the ego vehicle approaches a node where an instruction needs to be provided to the driver in order to follow the route path.

In step S103, sensor data, generated by a sensor unit 12 of the navigation system 1, may be processed in order to obtain information about vehicles in a region around the ego vehicle. For example, at least one of a position, a velocity, a heading, a turn signal, and/or a lane assignment of at least one vehicle around the ego vehicle may be detected. Additionally at least one of a color and/or a brand and/or a make and/or a turn signal and/or a type of the surrounding vehicle may be obtained. In particular, the information about surrounding vehicles may be obtained by processing sensor data received from at least one sensor. Alternatively or additionally, information about surrounding vehicles may be obtained by directly receiving data from the other vehicles using a vehicle-to-vehicle (V2V) interface. Information received via V2V may include information related to the trajectory of the surrounding vehicle, the brand, the make, the color, and the type of the surrounding vehicle.

In step S104, the obtained information may be used to determine trajectories of the surrounding vehicles. The trajectories of the surrounding vehicles may be determined for example based on at least one of the position, the velocity, the heading, the turn signal, and/or the lane assignment of at least one of the surrounding vehicles.

Then, in step S105, the trajectories of the other vehicles may be compared with the selected route path. The step of comparing trajectories with the route path may include calculating a match of the determined trajectory with the ego vehicle's route path on a map.

Next, in step S106, it may be determined whether or not there is a match between a trajectory of at least one surrounding vehicle and at least a portion of the selected route path of the ego vehicle. In other words, it may be determined whether or not one of the other vehicles was driving, is currently driving, or will be driving along the selected route path. The match only needs to be within a predetermined radius of the current position of the ego vehicle, for example within a predefined distance from the ego vehicle or within a predefined radius of a node in the route path such as an intersection. Moreover, the match does not necessarily need to be exact. For example, if the vehicle to follow is driving along a lane parallel to the ego vehicle, it may be enough to follow that vehicle by staying on the current lane. Thus, the criterion of matching trajectories may be evaluated on a functional basis, which leads to the desired result of driving along the selected route path rather than to exactly follow the movement of the surrounding vehicle.

If the outcome of the matching process is negative, the process returns to steps S103. Here, a negative outcome means that following the surrounding vehicle will not lead the ego vehicle along the selected route path.

If the outcome of the matching process in step S106 is positive, an instruction to follow the other vehicle whose trajectory matches the selected route match is generated in step S107. For example, the instruction may be generated comprising at least one of the detected color, the brand, the make, the type, and the turn signal of the other vehicle to be followed. Finally, in step S108, the generated instruction is output to the driver. For example, a visual instruction may be provided to the driver together with an audible command to follow the vehicle.

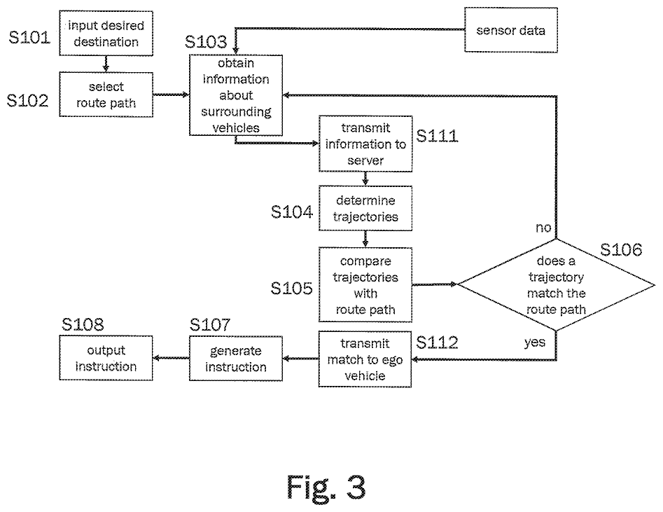

FIG. 3 illustrates a method for operating a navigation system for guiding a driver of an ego vehicle to a desired destination along a selected route path, according to one or more embodiments. The method may be carried out by a navigation system 1 as described above with reference to FIG. 1.

The method may include inputting a desired destination in step S101, selecting a route path in step S102, and obtaining information, via one or more sensors, about vehicles in a region around the ego vehicle in step S103. The obtained information on the surrounding vehicles may be transmitted to a server in step S111. Additionally, the selected route path of the ego vehicle may be transmitted to the server. The server may be remotely located from the ego vehicle. The ego vehicle may be in wireless communication with the server.

The method may include determining trajectories of the surrounding vehicles in step S104. That determination step, S104, may be performed by the server. Additionally, the method may include, in step S105, comparing determined trajectories of the surrounding vehicles with the selected path of the ego vehicle. Step S105 may also be performed by the server. Based on the comparison, the method, in step S106, may include determining whether or not there is a match between a trajectory of a surrounding vehicle and the selected route path of the ego vehicle. Step S106 may also be performed by the server. In the event of a positive determination indicating a match, the method may include step S112. In step S112, the server may transmit to the ego vehicle that there is a match. Based on the transmission of the positive determination to the ego vehicle, the method may include generating an instruction, in step S107, and outputting the instruction to the driver of the ego vehicle, in step S108.

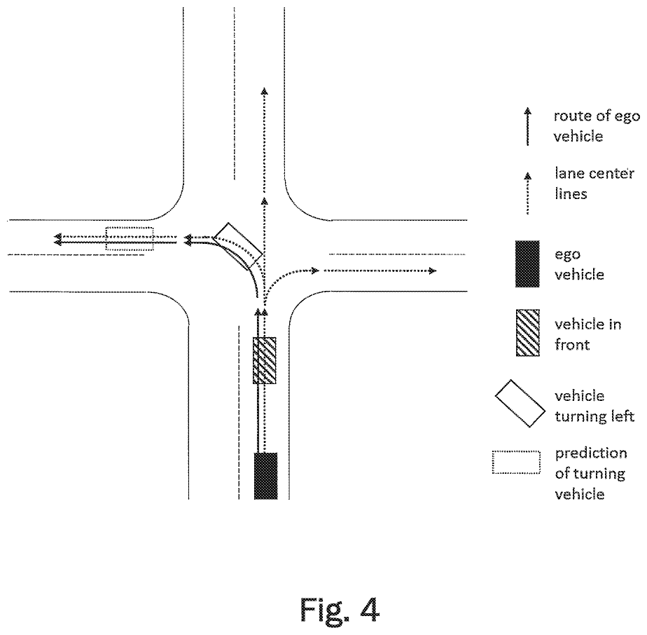

FIGS. 4 to 6 illustrate examples for route matching methods, which may be implemented in steps S104 to S106 of a process as described above with reference to FIGS. 2 and 3.

FIG. 4 illustrates an example for route matching using prediction of an environmental model. The environmental model may provide data such as center of road lanes and junctions and surrounding vehicles detected using sensors of the ego vehicle. In FIG. 4, the lane center lines are indicated by the dotted arrows. At the exemplary four-way junction, three directions are possible for vehicles approaching the junction such as the ego vehicle (black rectangle) or the vehicle in front (rectangle with stripes): turn left, turn right, or continue straight. These three possibilities are indicated by the dotted arrows marking the center lines. The planned route of the ego vehicle is indicated by the solid arrow and comprises a left turn at the junction. The prediction of the environmental model gives a high probability that the vehicle illustrated by the white rectangle will also turn left and thus travel along the same trajectory within the boundaries of the junctions as the ego vehicle. Moreover, the sensors may provide data indicating that the turning vehicle is red. As a result of the positive trajectory matching, a voice command may be generated such as “Follow the red vehicle turning left on the next junction!”

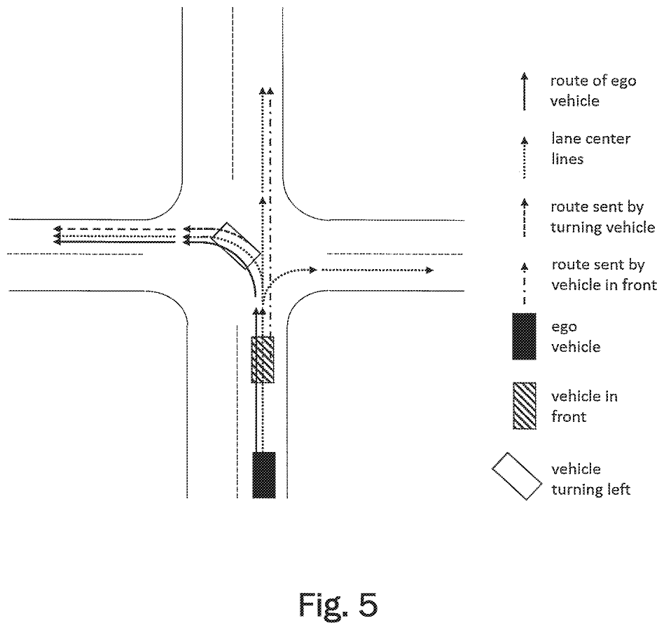

FIG. 5 illustrates an example for route matching using V2V. Similar to the situation depicted in FIG. 4, the ego vehicle approaches a junction where a left turn is necessary in order to follow the planned route (solid arrow). Two surrounding vehicles are present in front of the ego vehicle. A vehicle directly in front of the ego vehicle (dashed rectangle) may go straight ahead across the junction (dash-dotted arrow). Another vehicle (white rectangle) may take a left turn (dashed arrow). The ego vehicle may receive the routes of the surrounding vehicles by means of V2V-communication. Furthermore, the data transmitted by V2V may also include data about the surrounding vehicles such as their color. The trajectory matching process detects an overlap between the route sent by the vehicle turning left and the ego vehicle. As a result of the positive trajectory matching, a voice command may be generated such as “Follow the red vehicle turning left on the next junction!” Moreover, industry standards for V2V-communicationmay help the matching of trajectories of surrounding vehicles with the planned route. For example, the map database employed by different vehicles may differ such that direct matching of trajectories may not be possible. Thus, the matching process may require that the data received via V2V is analyzed in terms of road geometry, functional road classes of the roads, directional information, and speed information.

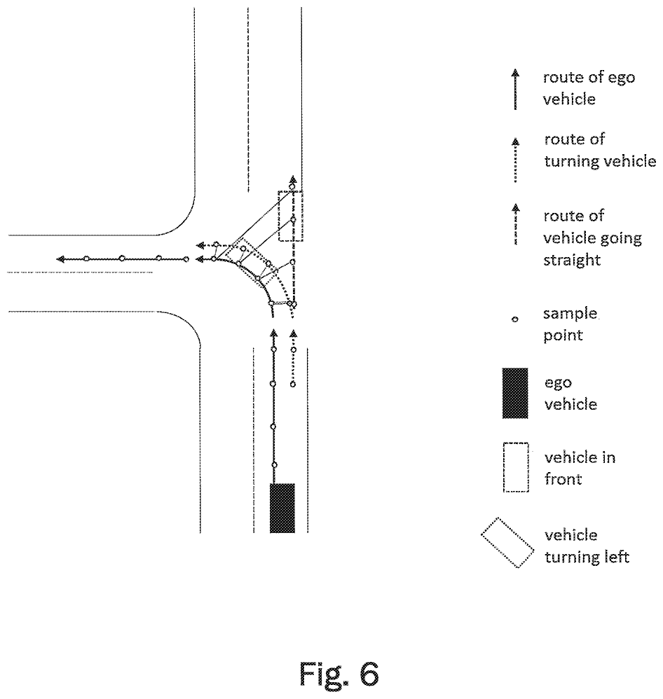

FIG. 6 illustrates an example for route matching based on geometrical relations between trajectories. A simple but powerful matching process may be based on geometrical information only. For example, the former trajectories as well as the current position and heading the surrounding vehicles (dotted rectangle and dashed rectangle) around the ego vehicle (black rectangle) may be known, for example from sensor data. At the junction depicted in FIG. 6, the planned route path of the ego vehicle makes a left turn. For the trajectories of both surrounding vehicles and the ego vehicle, sample points (small circles) may be calculated. Then the average distances indicated by the solid lines and dotted lines between the respective sample points may be computed by finding the closest sample point on the planned route path to each sample point on a surrounding vehicle's trajectory. The distance may be computed as the Euclidian distance between these sample points. The average Euclidian distance may be used as a basic measure expressing the quality of the match between the planned route and a trajectory of a surrounding vehicle. A smaller distance may indicate a better match. Once a trajectory of a surrounding vehicle with a sufficient match is identified, the matched surrounding vehicle may be used for generating an instruction for guiding the driver of the ego vehicle. In FIG. 6, the first sample points of the two trajectories of the surrounding vehicles have the same distance to the corresponding sample points of the ego vehicle's route path. However, after the turning point for the left turn, the distances to the sample points of the dashed trajectory are much higher than distances to the sample points of the dotted trajectory. Therefore, the process may return the result that the dotted trajectory matches the planned route path better than the dashed trajectory. For the purpose of creating an instruction, only vehicles, which have trajectory with a small average distance to the planned route path of the ego vehicle, may be selected. In the example of FIG. 6, an instruction to follow the vehicle of the dotted trajectory may be chosen.

The features described in herein can be relevant to one or more embodiments in any combination. The reference numerals in the claims have merely been introduced to facilitate reading of the claims. They are by no means meant to be limiting.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

### REFERENCE NUMERALS

1 navigation system
11 routing unit
12 sensor unit
13 processing unit
14 instruction unit
15 output unit
16 reception unit

What is claimed is:

1. A method for operating a navigation system of an ego vehicle, the method comprising:
obtaining information about vehicles in a region proximate the ego vehicle;
determining trajectories of the vehicles proximate the ego vehicle based on the obtained information;
comparing the trajectories of the vehicles proximate the ego vehicle with a selected route path of the ego vehicle; and
based on a determination that at least one vehicle proximate the ego vehicle was driving, is currently driving, or will be driving along the selected route pate, generating and outputting an instruction to a driver of the ego vehicle to follow the at least one vehicle.

2. The method of claim 1, wherein obtaining information proximate other vehicles includes: detecting at least one of a position, a velocity, a heading, a turn signal and a lane assignment of the at least one vehicle proximate the ego vehicle using sensor data generated by at least one sensor.

3. The method of claim 2, wherein determining the trajectories of the vehicles proximate the ego vehicle based on the obtained information includes determining the trajectories of the vehicles proximate the ego vehicle based on the at least one of the position, the velocity, the heading, the turn signal and the lane assignment of the at least one vehicle proximate the ego vehicle.

4. The method of claim 1, wherein obtaining information about vehicles proximate the ego vehicle includes detecting at least one of a color, a brand, a make, a turn signal, and a type of the at least one vehicle proximate the ego vehicle.

5. The method of claim 4, wherein generating the instruction to follow the at least one vehicle includes generating the instruction based on the at least one of the detected color, the brand, the make, the turn signal, and the type of the at least one.

6. The method of claim 1, wherein obtaining information about vehicles proximate the ego vehicle includes receiving data from the vehicles proximate the ego vehicle using a vehicle-to-vehicle (V2V) interface.

7. The method of claim 1, wherein the instruction is output to the driver using acoustic signals or optical signals.

8. The method of claim 1, further comprising transmitting the obtained information about vehicles proximate the ego vehicle to a server, wherein determining trajectories of the vehicles proximate the ego vehicle is performed by the server.

9. The method of claim 8, further comprising transmitting the selected route path to the server, wherein comparing the trajectories of the vehicles proximate the ego vehicle with the selected route path is performed by the server.

10. A system for operating a navigation system of an ego vehicle, the system comprising:
a memory; and
a processor, wherein the memory includes instructions that, when executed by the processor, cause the processor to:
obtain information about vehicles in a region proximate the ego vehicle;
determine trajectories of the vehicles proximate the ego vehicle based on the obtained information;
compare the trajectories of the vehicles proximate the ego vehicle with a selected route path of the ego vehicle; and
based on a determination that at least one vehicle proximate the ego vehicle was driving, is currently driving, or will be driving along the selected route pate, generate and output an instruction to a driver of the ego vehicle to follow the at least one vehicle.

11. The system of claim 10, wherein the instructions further cause the processor to detect at least one of a position, a velocity, a heading, a turn signal and a lane assignment of the at least one vehicle proximate the ego vehicle using sensor data generated by at least one sensor.

12. The system of claim 11, wherein the instructions further cause the processor to determine the trajectories of the vehicles proximate the ego vehicle based on the obtained information by determining the trajectories of the vehicles proximate the ego vehicle based on the at least one of the position, the velocity, the heading, the turn signal and the lane assignment of the at least one vehicle proximate the ego vehicle.

13. The system of claim 10, wherein the instructions further cause the processor to detect at least one of a color, a brand, a make, a turn signal, and a type of the at least one vehicle proximate the ego vehicle.

14. The system of claim 13, wherein the instructions further cause the processor to generate the instruction based on the at least one of the detected color, the brand, the make, the turn signal, and the type of the at least one.

15. The system of claim 10, wherein the instructions further cause the processor to receive data from the vehicles proximate the ego vehicle using a vehicle-to-vehicle (V2V) interface.

16. The system of claim 10, wherein instructions further cause the processor to output the instruction to the driver using acoustic signals.

17. The system of claim 10, wherein instructions further cause the processor to output the instruction to the driver using optical signals.

18. The system of claim 10, wherein instructions further cause the processor to transmit the obtained information about vehicles proximate the ego vehicle to a server, wherein the server is configured to determine trajectories of the vehicles proximate the ego vehicle.

19. The system of claim 18, herein instructions further cause the processor to transmit the selected route path to the server, wherein the server is configured to compare the trajectories of the vehicles proximate the ego vehicle with the selected route path.

20. A system for operating a navigation system of an ego vehicle, the system comprising:
a memory; and
a processor, wherein the memory includes instructions that, when executed by the processor, cause the processor to:
obtain information about vehicles in a region proximate the ego vehicle;
communicate the information about the vehicles to a server remotely located from the vehicle;
receive, from the server, trajectories of the vehicles proximate the ego vehicle, wherein the trajectories are determined based on the obtained information;
compare the trajectories of the vehicles proximate the ego vehicle with a selected route path of the ego vehicle; and
based on a determination that a trajectory of at least one vehicle proximate the ego vehicle corresponds to the selected route pate, generate an instruction to a driver of the ego vehicle to follow the at least one vehicle.
